(19) United States
(12) Patent Application Publication
(10) Pub. No.: US 2024/0146447 A1
(43) Pub. Date: May 2, 2024

(54) METHOD AND DEVICE IN NODES USED FOR WIRELESS COMMUNICATION

(71) Applicants: Yang HU, Shanghai (CN); Xiaobo ZHANG, Shanghai (CN)

(72) Inventors: Yang HU, Shanghai (CN); Xiaobo ZHANG, Shanghai (CN)

(73) Assignee: SHANGHAI LANGBO COMMUNICATION TECHNOLOGY COMPANY LIMITED, Shanghai (CN)

(21) Appl. No.: 18/408,578

(22) Filed: Jan. 10, 2024

Related U.S. Application Data
(63) Continuation of application No. PCT/CN2022/104053, filed on Jul. 6, 2022.

(30) Foreign Application Priority Data
Jul. 18, 2021 (CN) 202110810123.1

(51) Int. Cl. H04L 1/00; H04L 1/1812

(52) U.S. Cl. CPC H04L 1/003; H04L 1/1812

(57) ABSTRACT

The present application discloses a method and a device in a node for wireless communications. A first receiver receives Q1 bit blocks, Q1 being a positive integer greater than 1; a first transmitter, transmits a first message and a first bit block; herein, the first message is used for indicating an associated bit block set of each bit in the first bit block, and the associated bit block set of each bit in the first bit block comprises at least one bit block among the Q1 bit blocks, and each bit in the first bit block is used for indicating whether a corresponding associated bit block set is correctly decoded.

### CROSS REFERENCE TO RELATED APPLICATIONS

This application is the continuation of the international patent application No. PCT/CN2022/104053, filed on Jul. 6, 2022, and claims the priority benefit of Chinese Patent Application No. 202110810123.1, filed on Jul. 18, 2021, the full disclosure of which is incorporated herein by reference.

### BACKGROUND

### Technical Field

The present application relates to transmission methods and devices in wireless communication systems, and in particular to a method and device for radio signal transmission in a wireless communication system supporting cellular networks.

### Related Art

In designing a 5G New Radio (NR) system, to support diversified communication traffics, data rate and reliability are two important factors to be taken into account. The transmission of traffics with high data rate and high reliability, such as Extended Reality (XR), will bring about a large amount of Hybrid Automatic Repeat reQuest ACKnowledgement (HARQ-ACK) feedback overhead.

### SUMMARY

The design of a rational feedback method for saving HARQ-ACK feedback overhead is a key problem that needs to be solved.

To address the above problem, the present application provides a solution. It should be noted that although the description above only takes the HARQ-ACK feedback for high-data-rate and high-reliability traffics in 5G NR as an example, this application is also applicable to other scenarios, such as scenarios of other traffic types in 5G NR, scenarios in 6G networks and V2X, where similar technical effects can be achieved. Additionally, the adoption of a unified solution for various scenarios, including but not limited to 5G NR, or scenarios in 6G networks or V2X, contributes to the reduction of hardcore complexity and costs, or an enhancement in performance. It should be noted that if no conflict is incurred, embodiments in any node in the present application and the characteristics of the embodiments are also applicable to any other node, and vice versa. What's more, the embodiments in the present application and the characteristics in the embodiments can be arbitrarily combined if there is no conflict.

In one embodiment, interpretations of the terminology in the present application refer to definitions given in the 3GPP TS36 series.

In one embodiment, interpretations of the terminology in the present application refer to definitions given in the 3GPP TS38 series.

In one embodiment, interpretations of the terminology in the present application refer to definitions given in the 3GPP TS37 series.

In one embodiment, interpretations of the terminology in the present application refer to definitions given in Institute of Electrical and Electronics Engineers (IEEE) protocol specifications.

The present application provides a method in a first node for wireless communications, comprising:
receiving Q1 bit blocks, Q1 being a positive integer greater than 1; and
transmitting a first message and a first bit block;
herein, the first message is used for indicating an associated bit block set of each bit in the first bit block, and the associated bit block set of each bit in the first bit block comprises at least one bit block among the Q1 bit blocks, and each bit in the first bit block is used for indicating whether a corresponding associated bit block set is correctly decoded.

In one embodiment, a problem to be solved in the present application includes: how to reduce the overhead for retransmission with limited HARQ-ACK feedback overhead.

In one embodiment, a problem to be solved in the present application includes: how to achieve optimization of the choice between the HARQ-ACK feedback overhead and the retransmission overhead.

In one embodiment, characteristics of the above method include: the first node not only transmits HARQ-ACK information bits but also transmits a message indicating an association relationship between the HARQ-ACK information bits and the Q1 bit blocks.

In one embodiment, characteristics of the above method include: the UE flexibly determines an association relationship between each bit in the first bit block and the Q1 bit blocks, and reports the association relationship to the base station.

In one embodiment, an advantage of the above method includes: It helps save the HARQ-ACK feedback overhead.

In one embodiment, an advantage of the above method includes: the first node can decide an association relationship between each bit in the first bit block and Q1 bit blocks flexibly according to which bit block(s) among the Q1 bit blocks is(are) correctly decoded, which contributes to a reduction of overhead for retransmission with limited HARQ-ACK feedback overhead.

In one embodiment, an advantage of the above method includes: it helps reduce unnecessary retransmission overhead.

In one embodiment, an advantage of the above method includes: it increases the resource utilization ratio of the system.

According to one aspect of the present application, the above method is characterized in that,

the first bit block consists of Q2 bit(s), Q2 being a positive integer less than Q1; the associated bit block set of each bit of the Q2 bit(s) consists of one or multiple bit blocks among the Q1 bit blocks; any of the Q1 bit blocks is associated with only one bit of the Q2 bit(s).

According to one aspect of the present application, the above method is characterized in that, any of the Q1 bit blocks belongs to only one bit block group of Q3 bit block groups; any bit in the first bit block belongs to only one bit sub-block of Q3 bit sub-blocks; the Q3 bit sub-blocks respectively indicate whether bit blocks in the Q3 bit block groups are correctly decoded, the Q3 bit sub-blocks respectively corresponding to the Q3 bit block groups; for any of the Q3 bit sub-blocks, the first message is used for indicating an associated bit block set of each bit from a corresponding bit block group; Q3 is a positive integer greater than 1 and less than Q1.

In one embodiment, characteristics of the above method include: the first message is used for indicating a corresponding relationship between each {bit block group, bit sub-block}-pair; an advantage of the above method includes: it helps reduce the overhead of the first message.

According to one aspect of the present application, the above method is characterized in that,
a second bit block consists of Q4 bits, and each bit block among the Q1 bit blocks corresponds to one bit among the Q4 bits, Q4 being a positive integer greater than 1; the first message is used for indicating an associated bit set of each bit in the first bit block, the associated bit set of each bit in the first bit block comprising at least one bit among the Q4 bits; an associated bit block set of a given bit in the first bit block comprises all bit block(s) among the Q1 bit blocks that corresponds/correspond to any bit in an associated bit set of the given bit in the first bit block.

According to one aspect of the present application, the above method is characterized in comprising:
receiving a first signaling;
herein, the first signaling is used for indicating L1 association methods, and the first message is used for indicating a first association method among the L1 association methods, the first association method being used to determine bit block(s) associated with each bit in the first bit block among the Q1 bit blocks; L1 is a positive integer greater than 1.

According to one aspect of the present application, the above method is characterized in that,
the first message and the first bit block are transmitted on a same physical layer channel.

According to one aspect of the present application, the above method is characterized in that, the first message and the first bit block are transmitted respectively on two physical layer channels.

The present application provides a method in a second node for wireless communications, comprising:
transmitting Q1 bit blocks, Q1 being a positive integer greater than 1; and
receiving a first message and a first bit block;
herein, the first message is used for indicating an associated bit block set of each bit in the first bit block, and the associated bit block set of each bit in the first bit block comprises at least one bit block among the Q1 bit blocks, and each bit in the first bit block is used for indicating whether a corresponding associated bit block set is correctly decoded.

According to one aspect of the present application, the above method is characterized in that,
the first bit block consists of Q2 bit(s), Q2 being a positive integer less than Q1; the associated bit block set of each bit of the Q2 bit(s) consists of one or multiple bit blocks among the Q1 bit blocks; any of the Q1 bit blocks is associated with only one bit of the Q2 bit(s).

According to one aspect of the present application, the above method is characterized in that,
any of the Q1 bit blocks belongs to only one bit block group of Q3 bit block groups; any bit in the first bit block belongs to only one bit sub-block of Q3 bit sub-blocks; the Q3 bit sub-blocks respectively indicate whether bit blocks in the Q3 bit block groups are correctly decoded, the Q3 bit sub-blocks respectively corresponding to the Q3 bit block groups; for any of the Q3 bit sub-blocks, the first message is used for indicating an associated bit block set of each bit from a corresponding bit block group; Q3 is a positive integer greater than 1 and less than Q1.

According to one aspect of the present application, the above method is characterized in that,
a second bit block consists of Q4 bits, and each bit block among the Q1 bit blocks corresponds to one bit among the Q4 bits, Q4 being a positive integer greater than 1; the first message is used for indicating an associated bit set of each bit in the first bit block, the associated bit set of each bit in the first bit block comprising at least one bit among the Q4 bits; an associated bit block set of a given bit in the first bit block comprises all bit block(s) among the Q1 bit blocks that corresponds/correspond to any bit in an associated bit set of the given bit in the first bit block.

According to one aspect of the present application, the above method is characterized in comprising:
transmitting a first signaling;
herein, the first signaling is used for indicating L1 association methods, and the first message is used for indicating a first association method among the L1 association methods, the first association method being used to determine bit block(s) associated with each bit in the first bit block among the Q1 bit blocks; L1 is a positive integer greater than 1.

According to one aspect of the present application, the above method is characterized in that,
the first message and the first bit block are transmitted on a same physical layer channel.

According to one aspect of the present application, the above method is characterized in that,
the first message and the first bit block are transmitted respectively on two physical layer channels.

The present application provides a first node for wireless communications, comprising:
a first receiver, receiving Q1 bit blocks, Q1 being a positive integer greater than 1; and
a first transmitter, transmitting a first message and a first bit block;
herein, the first message is used for indicating an associated bit block set of each bit in the first bit block, and the associated bit block set of each bit in the first bit block comprises at least one bit block among the Q1 bit blocks, and each bit in the first bit block is used for indicating whether a corresponding associated bit block set is correctly decoded.

The present application provides a second node for wireless communications, comprising:
a second transmitter, transmitting Q1 bit blocks, Q1 being a positive integer greater than 1; and
a second receiver, receiving a first message and a first bit block;
herein, the first message is used for indicating an associated bit block set of each bit in the first bit block, and the associated bit block set of each bit in the first bit block comprises at least one bit block among the Q1 bit blocks, and each bit in the first bit block is used for indicating whether a corresponding associated bit block set is correctly decoded.

In one embodiment, the method in the present application has the following advantages:
It helps save the HARQ-ACK feedback overhead; It helps reduce the overhead for retransmission with limited HARQ-ACK feedback overhead;
It helps reduce unnecessary retransmission overhead; It increases the resource utilization ratio of the system.

### BRIEF DESCRIPTION OF THE DRAWINGS

Other features, objects and advantages of the present application will become more apparent from the detailed description of non-restrictive embodiments taken in conjunction with the following drawings:

FIG. 1 illustrates a flowchart of processing of a first node according to one embodiment of the present application.

FIG. 2 illustrates a schematic diagram of a network architecture according to one embodiment of the present application.

FIG. 3 illustrates a schematic diagram of a radio protocol architecture of a user plane and a control plane according to one embodiment of the present application.

FIG. 4 illustrates a schematic diagram of a first communication device and a second communication device according to one embodiment of the present application.

FIG. 5 illustrates a flowchart of signal transmission according to one embodiment of the present application.

FIG. 6 illustrates a schematic diagram of a relationship between a given bit of Q2 bit(s) and Q1 bit blocks according to one embodiment of the present application.

FIG. 7 illustrates a schematic diagram of relations among Q1 bit blocks, Q3 bit block groups, a first bit block and Q3 bit sub-blocks according to one embodiment of the present application.

FIG. 8 illustrates a schematic diagram of relations among Q1 bit blocks, a second bit block, Q4 bits, a first bit block and a first message according to one embodiment of the present application.

FIG. 9 illustrates a schematic diagram of relations among a given bit in a first bit block, Q1 bit blocks and Q4 bits according to one embodiment of the present application.

FIG. 10 illustrates a schematic diagram of relations among a first signaling, L1 association methods, a first message, a first association method and bit block(s) associated with each bit in the first bit block among Q1 bit blocks according to one embodiment of the present application.

FIG. 11 illustrates a schematic diagram of a method of transmitting a first message and a first bit block according to one embodiment of the present application.

FIG. 12 illustrates a schematic diagram of a method of transmitting a first message and a first bit block according to one embodiment of the present application.

FIG. 13 illustrates a structure block diagram of a processing device in a first node according to one embodiment of the present application.

FIG. 14 illustrates a structure block diagram a processing device in a second node according to one embodiment of the present application.

### DESCRIPTION OF THE EMBODIMENTS

The technical scheme of the present application is described below in further details in conjunction with the drawings. It should be noted that the embodiments of the present application and the characteristics of the embodiments may be arbitrarily combined if no conflict is caused.

### Embodiment 1

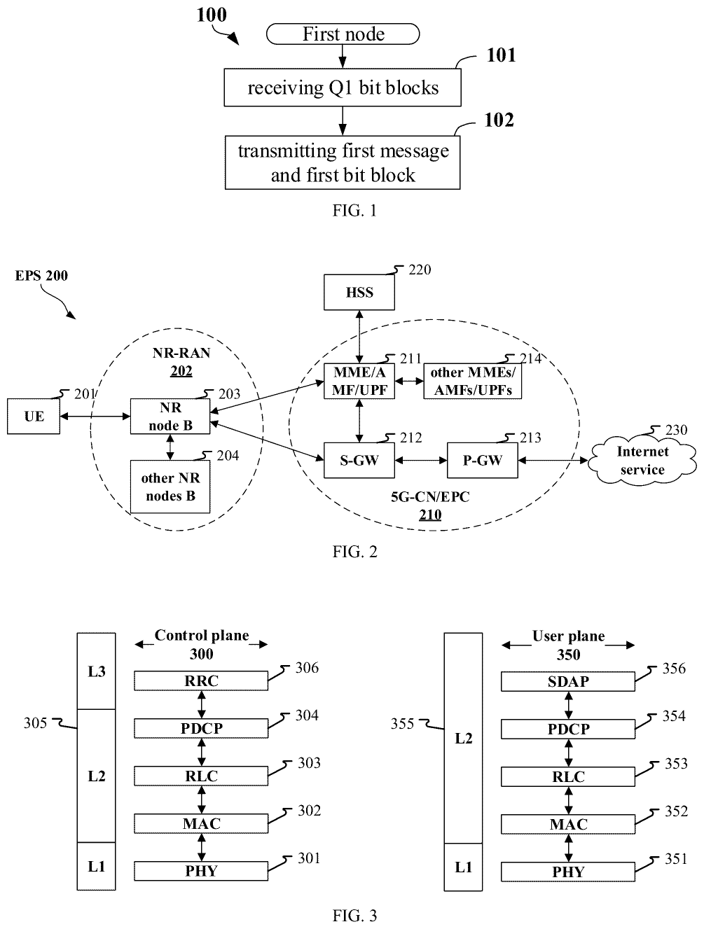

Embodiment 1 illustrates a flowchart of processing of a first node according to one embodiment of the present application, as shown in FIG. 1.

In Embodiment 1, the first node in the present application receives Q1 bit blocks in step 101; and transmits a first message and a first bit block in step 102.

In Embodiment 1, Q1 is a positive integer greater than 1; the first message is used for indicating an associated bit block set of each bit in the first bit block, and the associated bit block set of each bit in the first bit block comprises at least one bit block among the Q1 bit blocks, and each bit in the first bit block is used for indicating whether a corresponding associated bit block set is correctly decoded.

In one embodiment, any of the Q1 bit blocks comprises multiple bits.

In one embodiment, any of the Q1 bit blocks is a Transport Block (TB).

In one embodiment, any of the Q1 bit blocks comprises one TB.

In one embodiment, any of the Q1 bit blocks is a TB or a CBG.

In one embodiment, any of the Q1 bit blocks comprises a TB or a DCI format.

In one embodiment, any of the Q1 bit blocks comprises at least one Code Block Group (CBG).

In one embodiment, the Q1 bit blocks are respectively transmitted on Q1 physical layer channels.

In one embodiment, the Q1 bit blocks are respectively transmitted on Q1 PDSCHs.

In one embodiment, the Q1 bit blocks are respectively transmitted on Q1 SPS PDSCHs.

In one embodiment, the Q1 bit blocks are respectively transmitted on Q1 sidelink physical layer channels.

In one embodiment, any two bit blocks among the Q1 bit blocks are of identical sizes.

In one embodiment, at least two bit blocks among the Q1 bit blocks are of different sizes.

In one embodiment, at least two bit blocks among the Q1 bit blocks are respectively transmitted on two physical layer channels.

In one embodiment, each of the Q1 bit blocks has been through at least Cyclic Redundancy Check (CRC) attachment, Code Block Segmentation, Code Block CRC attachment, Channel Coding, Rate Matching and Code Block Concatenation, Scrambling, and Modulation and Resource Block Mapping before being transmitted on a physical layer channel.

In one embodiment, each of the Q1 bit blocks has been through at least CRC attachment, Channel Coding and Rate Matching, Scrambling, and Modulation and Resource Block Mapping before being transmitted on a physical layer channel.

In one embodiment, each of the Q1 bit blocks has been through at least CRC attachment, Code Block Segmentation, Code Block CRC attachment, Channel Coding, Rate Matching and Code Block Concatenation, Scrambling, Modulation, Layer Mapping, Antenna Port Mapping and Resource Block Mapping before being transmitted on a physical layer channel.

In one embodiment, each of the Q1 bit blocks has been through at least CRC attachment, Channel Coding and Rate Matching, Scrambling, Modulation, Layer Mapping, Antenna Port Mapping and Resource Block Mapping before being transmitted on a physical layer channel.

In one embodiment, an output by each of the Q1 bit blocks through at least part of CRC attachment, Code Block Segmentation, Code Block CRC attachment, Channel Coding, Rate Matching, Code Block Concatenation, Scrambling, Modulation, Spreading, Layer Mapping, Precoding, Mapping to Physical Resources, Multicarrier Symbol Generation, and Modulation and Upconversion is transmitted on a physical channel.

In one embodiment, an associated bit block set of a given bit in the first bit block is formed by all bit block(s) associated with the given bit in the first bit block.

In one embodiment, an associated bit block set of a given bit in the first bit block is formed by all bit block(s) associated with the given bit in the first bit block among the Q1 bit blocks.

In one embodiment, any bit block in an associated bit block set of any bit in the first bit block is one of the Q1 bit blocks.

In one embodiment, the associated bit block set of each bit in the first bit block consists of one or multiple bit blocks among the Q1 bit blocks.

In one embodiment, any of the Q1 bit blocks can only be associated with one bit in the first bit block.

In one embodiment, there is one bit block among the Q1 bit blocks that is associated with multiple bits in the first bit block.

In one embodiment, the first message is a value of one bit or values of multiple bits.

In one embodiment, the first message is one or 0 or 1.

In one embodiment, the first message is one of 00, 01, 10 or 11.

In one embodiment, the first message is one of 000, 010, 100, 110, 001, 011, 101 or 111.

In one embodiment, the first message is expressed in one or multiple bits.

In one embodiment, the first message is a physical layer message.

In one embodiment, the first message is a UCI (i.e., Uplink Control Information), and the first bit block is a UCI.

In one embodiment, the first message is a MAC CE, and the first bit block is a UCI.

In one embodiment, the first message is an RRC layer message, and the first bit block is a UCI.

In one embodiment, the first bit block comprises multiple bits.

In one embodiment, the first bit block is a bit block by which each bit comprised is used for indicating whether one or more bit blocks among the Q1 bit blocks is(are) correctly decoded.

In one embodiment, each bit comprised by the first bit block is a HARQ-ACK information bit.

In one embodiment, the first bit block is a HARQ-ACK codebook.

In one embodiment, the first bit block belongs to a HARQ-ACK codebook.

In one embodiment, the first bit block is generated by a HARQ-ACK codebook.

In one embodiment, the first message is used for explicitly indicating an associated bit block set of each bit in the first bit block.

In one embodiment, the first message is used for indicating an index of each bit block in an associated bit block set of each bit in the first bit block among the Q1 bit blocks.

In one embodiment, the first message is used for implicitly indicating an associated bit block set of each bit in the first bit block.

In one embodiment, the statement in the present application that the first message is used for indicating an associated bit block set of each bit in the first bit block means that: a second bit block consists of Q4 bits, and each bit block among the Q1 bit blocks corresponds to one bit among the Q4 bits, Q4 being a positive integer greater than 1; the first message is used for indicating an associated bit set of each bit in the first bit block, and the associated bit set of each bit in the first bit block comprises at least one bit of the Q4 bits, and an associated bit block set of a given bit in the first bit block comprises all bit block(s) among the Q1 bit blocks that corresponds/correspond to any bit in the associated bit set of the given bit in the first bit block.

In one embodiment, the statement in the present application that the first message is used for indicating an associated bit block set of each bit in the first bit block means that: the first message is used for indicating a first association method among L1 association methods indicated by a signaling, the first association method being used to determine bit block(s) associated with each bit in the first bit block among the Q1 bit blocks; L1 is a positive integer greater than 1.

In one embodiment, the first bit block is a bit block by which each bit comprised is used for indicating whether at least one bit block among the Q1 bit blocks is correctly decoded.

In one embodiment, the statement in the present application that each bit in the first bit block is used for indicating whether a corresponding associated bit block set is correctly decoded means that: each bit in the first bit block is used for indicating whether all bit block(s) in a corresponding associated bit block set is(are) correctly decoded.

In one embodiment, the statement in the present application that each bit in the first bit block is used for indicating whether a corresponding associated bit block set is correctly decoded means that: for any bit in the first bit block, a bit value 0 is used for indicating that all bit block(s) in a corresponding associated bit block set is(are) correctly decoded, while a bit value 1 is used for indicating that at least one bit block in a corresponding associated bit block set is not correctly decoded.

In one embodiment, the statement in the present application that each bit in the first bit block is used for indicating whether a corresponding associated bit block set is correctly decoded means that: for any bit in the first bit block, a bit value 1 is used for indicating that all bit block(s) in a corresponding associated bit block set is(are) correctly decoded, while a bit value 0 is used for indicating that at least one bit block in a corresponding associated bit block set is not correctly decoded.

In one embodiment, the statement in the present application that each bit in the first bit block is used for indicating whether a corresponding associated bit block set is correctly decoded means that: each bit in the first bit block is used for indicating whether there is at least one bit block in a corresponding associated bit block set being correctly decoded.

In one embodiment, the statement in the present application that each bit in the first bit block is used for indicating whether a corresponding associated bit block set is correctly decoded means that: for any bit in the first bit block, a bit value 0 is used for indicating that none of bit blocks in a corresponding associated bit block set is correctly decoded, while a bit value 1 is used for indicating that at least one bit block in a corresponding associated bit block set is correctly decoded.

In one embodiment, the statement in the present application that each bit in the first bit block is used for indicating whether a corresponding associated bit block set is correctly decoded means that: for any bit in the first bit block, a bit value 1 is used for indicating that none of bit blocks in a corresponding associated bit block set is correctly decoded, while a bit value 0 is used for indicating that at least one bit block in a corresponding associated bit block set is correctly decoded.

In one embodiment, the first bit block consists of Q2 bits, Q2 being a positive integer less than Q1; the associated bit block set of each bit of the Q2 bits consists of one or multiple bit blocks among the Q1 bit blocks; any of the Q1 bit blocks is associated with at least one bit of the Q2 bits, and at least one of the Q1 bit blocks is associated with multiple bits among the Q2 bits.

In one embodiment, the first bit block consists of Q2 bits, Q2 being a positive integer no less than Q1; the associated bit block set of each bit of the Q2 bits consists of one or multiple bit blocks among the Q1 bit blocks; any of the Q1 bit blocks is associated with at least one bit of the Q2 bits.

In one embodiment, the first bit block consists of Q2 bits, Q2 being a positive integer greater than Q1; the associated bit block set of each bit of the Q2 bits consists of one or multiple bit blocks among the Q1 bit blocks; any of the Q1 bit blocks is associated with at least one bit of the Q2 bits, and at least one of the Q1 bit blocks is associated with multiple bits among the Q2 bits.

In one embodiment, any of the Q1 bit blocks belongs to one bit block group of Q3 bit block groups, and at least one of the Q1 bit blocks belongs to multiple bit block groups among the Q3 bit block groups; any bit in the first bit block belongs to only one bit sub-block of Q3 bit sub-blocks; the Q3 bit sub-blocks respectively indicate whether bit blocks in the Q3 bit block groups are correctly decoded, the Q3 bit sub-blocks respectively corresponding to the Q3 bit block groups; for any of the Q3 bit sub-blocks, the first message is used for indicating an associated bit block set of each bit from a corresponding bit block group; Q3 is a positive integer greater than 1 and less than Q1.

In one embodiment, any of the Q1 bit blocks belongs to only one bit block group of Q3 bit block group(s); any bit in the first bit block belongs to only one bit sub-block of Q3 bit sub-block(s); the Q3 bit sub-block(s) indicates/respectively indicate whether bit blocks in the Q3 bit block group(s) are correctly decoded, the Q3 bit sub-block(s) (respectively) corresponding to the Q3 bit block group(s); for any of the Q3 bit sub-block(s), the first message is used for indicating an associated bit block set of each bit from a corresponding bit block group; Q3 is equal to 1.

### Embodiment 2

Embodiment 2 illustrates a schematic diagram of a network architecture according to the present application, as shown in FIG. 2.

FIG. 2 is a diagram illustrating a network architecture 200 of 5G NR, Long-Term Evolution (LTE) and Long-Term Evolution Advanced (LTE-A) systems. The 5G NR or LTE network architecture 200 may be called an Evolved Packet System (EPS) 200 or other suitable terminology. The EPS 200 may comprise one or more UEs 201, an NG-RAN 202, an Evolved Packet Core/5G-Core Network (EPC/5G-CN) 210, a Home Subscriber Server (HSS) 220 and an Internet Service 230. The EPS 200 may be interconnected with other access networks. For simple description, the entities/interfaces are not shown. As shown in FIG. 2, the EPS 200 provides packet switching services. Those skilled in the art will find it easy to understand that various concepts presented throughout the present application can be extended to networks providing circuit switching services or other cellular networks. The NG-RAN 202 comprises an NR node B (gNB) 203 and other gNBs 204. The gNB 203 provides UE 201 oriented user plane and control plane terminations. The gNB 203 may be connected to other gNBs 204 via an Xn interface (for example, backhaul). The gNB 203 may be called abase station, a base transceiver station, a radio base station, a radio transceiver, a transceiver function, a Base Service Set (BSS), an Extended Service Set (ESS), a Transmitter Receiver Point (TRP) or some other applicable terms. The gNB 203 provides an access point of the EPC/5G-CN 210 for the UE 201. Examples of UE 201 include cellular phones, smart phones, Session Initiation Protocol (SIP) phones, laptop computers, Personal Digital Assistant (PDA), Satellite Radios, non-terrestrial base station communications, satellite mobile communications, Global Positioning Systems (GPSs), multimedia devices, video devices, digital audio players (for example, MP3 players), cameras, games consoles, unmanned aerial vehicles, air vehicles, narrow-band physical network equipment, machine-type communication equipment, land vehicles, automobiles, wearable equipment, or any other devices having similar functions. Those skilled in the art also can call the UE 201 a mobile station, a subscriber station, a mobile unit, a subscriber unit, a wireless unit, a remote unit, a mobile device, a wireless device, a radio communication device, a remote device, a mobile subscriber station, an access terminal, a mobile terminal, a wireless terminal, a remote terminal, a handset, a user proxy, a mobile client, a client or some other appropriate terms. The gNB 203 is connected to the EPC/5G-CN 210 via an S1/NG interface. The EPC/5G-CN 210 comprises a Mobility Management Entity (MME)/Authentication Management Field (AMF)/User Plane Function (UPF) 211, other MMEs/AMFs/UPFs 214, a Service Gateway (S-GW) 212 and a Packet Date Network Gateway (P-GW) 213. The MME/AMF/UPF 211 is a control node for processing a signaling between the UE 201 and the EPC/5G-CN 210. Generally, the MME/AMF/UPF 211 provides bearer and connection management. All user Internet Protocol (IP) packets are transmitted through the S-GW 212. The S-GW 212 is connected to the P-GW 213. The P-GW 213 provides UE IP address allocation and other functions. The P-GW 213 is connected to the Internet Service 230. The Internet Service 230 comprises IP services corresponding to operators, specifically including Internet, Intranet, IP Multimedia Subsystem (IMS) and Packet Switching Streaming (PSS) services.

In one embodiment, the UE 201 corresponds to the first node in the present application.

In one embodiment, the UE 201 corresponds to the second node in the present application.

In one embodiment, the gNB 203 corresponds to the first node in the present application.

In one embodiment, the gNB203 corresponds to the second node in the present application.

In one embodiment, the UE 201 corresponds to the first node in the present application, and the gNB203 corresponds to the second node in the present application.

In one embodiment, the gNB 203 is a MacroCellular base station.

In one embodiment, the gNB203 is a Micro Cell base station.

In one embodiment, the gNB 203 is a PicoCell base station.

In one embodiment, the gNB203 is a Femtocell.

In one embodiment, the gNB203 is a base station supporting large time-delay difference.

In one embodiment, the gNB203 is a flight platform.

In one embodiment, the gNB203 is satellite equipment.

In one embodiment, the first node and the second node in the present application both correspond to the UE 201, for instance, V2X communications is performed between the first node and the second node.

### Embodiment 3

Embodiment 3 illustrates a schematic diagram of a radio protocol architecture of a user plane and a control plane according to the present application, as shown in FIG. 3. FIG. 3 is a schematic diagram illustrating an embodiment of a radio protocol architecture of a user plane 350 and a control plane 300. In FIG. 3, the radio protocol architecture for a control plane 300 between a first communication node (UE, gNB or, RSU in V2X) and a second communication node (gNB, UE, or RSU in V2X), or between two UEs, is represented by three layers, which are a layer 1, a layer 2 and a layer 3, respectively. The layer 1 (L1) is the lowest layer which performs signal processing functions of various PHY layers. The L1 is called PHY 301 in the present application. The layer 2 (L2) 305 is above the PHY 301, and is in charge of the link between the first communication node and the second communication node or between two UEs via the PHY 301. The L2 305 comprises a Medium Access Control (MAC) sublayer 302, a Radio Link Control (RLC) sublayer 303 and a Packet Data Convergence Protocol (PDCP) sublayer 304. All the three sublayers terminate at the second communication nodes of the network side. The PDCP sublayer 304 provides multiplexing among variable radio bearers and logical channels. The PDCP sublayer 304 provides security by encrypting a packet and provides support for handover of a first communication node between second communication nodes. The RLC sublayer 303 provides segmentation and reassembling of a higher-layer packet, retransmission of a lost packet, and reordering of a packet so as to compensate the disordered receiving caused by Hybrid Automatic Repeat reQuest (HARQ). The MAC sublayer 302 provides multiplexing between a logical channel and a transport channel. The MAC sublayer 302 is also responsible for allocating between first communication nodes various radio resources (i.e., resource block) in a cell. The MAC sublayer 302 is also in charge of HARQ operation. In the control plane 300, The RRC sublayer 306 in the L3 layer is responsible for acquiring radio resources (i.e., radio bearer) and configuring the lower layer using an RRC signaling between the second communication node and the first communication node. The radio protocol architecture in the user plane 350 comprises the L1 layer and the L2 layer. In the user plane 350, the radio protocol architecture used for the first communication node and the second communication node in a PHY layer 351, a PDCP sublayer 354 of the L2 layer 355, an RLC sublayer 353 of the L2 layer 355 and a MAC sublayer 352 of the L2 layer 355 is almost the same as the radio protocol architecture used for corresponding layers and sublayers in the control plane 300, but the PDCP sublayer 354 also provides header compression used for higher-layer packet to reduce radio transmission overhead. The L2 layer 355 in the user plane 350 also comprises a Service Data Adaptation Protocol (SDAP) sublayer 356, which is in charge of the mapping between QoS streams and a Data Radio Bearer (DRB), so as to support diversified traffics. Although not described in FIG. 3, the first communication node may comprise several higher layers above the L2 355, such as a network layer (i.e., IP layer) terminated at a P-GW 213 of the network side and an application layer terminated at the other side of the connection (i.e., a peer UE, a server, etc.).

In one embodiment, the radio protocol architecture in FIG. 3 is applicable to the first node in the present application.

In one embodiment, the radio protocol architecture in FIG. 3 is applicable to the second node in the present application.

In one embodiment, the first signaling in the present application is generated by the RRC sublayer 306.

In one embodiment, the first signaling in the present application is generated by the MAC sublayer 302.

In one embodiment, the first signaling in the present application is generated by the MAC sublayer 352.

In one embodiment, the first signaling in the present application is generated by the PHY 301.

In one embodiment, the first signaling in the present application is generated by the PHY 351.

In one embodiment, one of the Q1 bit blocks in the present application is generated by the SDAP sublayer 356.

In one embodiment, one of the Q1 bit blocks in the present application is generated by the RRC sublayer 306.

In one embodiment, one of the Q1 bit blocks in the present application is generated by the MAC sublayer 302.

In one embodiment, one of the Q1 bit blocks in the present application is generated by the MAC sublayer 352.

In one embodiment, one of the Q1 bit blocks in the present application is generated by the PHY301.

In one embodiment, one of the Q1 bit blocks in the present application is generated by the PHY351.

In one embodiment, the first message in the present application is generated by the RRC sublayer 306.

In one embodiment, the first message in the present application is generated by the MAC sublayer 302.

In one embodiment, the first message in the present application is generated by the MAC sublayer 352.

In one embodiment, the first message in the present application is generated by the PHY 301.

In one embodiment, the first message in the present application is generated by the PHY 351.

In one embodiment, the first bit block in the present application is generated by the RRC sublayer 306.

In one embodiment, the first bit block in the present application is generated by the MAC sublayer 302.

In one embodiment, the first bit block in the present application is generated by the MAC sublayer 352.

In one embodiment, the first bit block in the present application is generated by the PHY 301.

In one embodiment, the first bit block in the present application is generated by the PHY 351.

In one embodiment, the second bit block in the present application is generated by the RRC sublayer 306.

In one embodiment, the second bit block in the present application is generated by the MAC sublayer 302.

In one embodiment, the second bit block in the present application is generated by the MAC sublayer 352.

In one embodiment, the second bit block in the present application is generated by the PHY 301.

In one embodiment, the second bit block in the present application is generated by the PHY 351.

### Embodiment 4

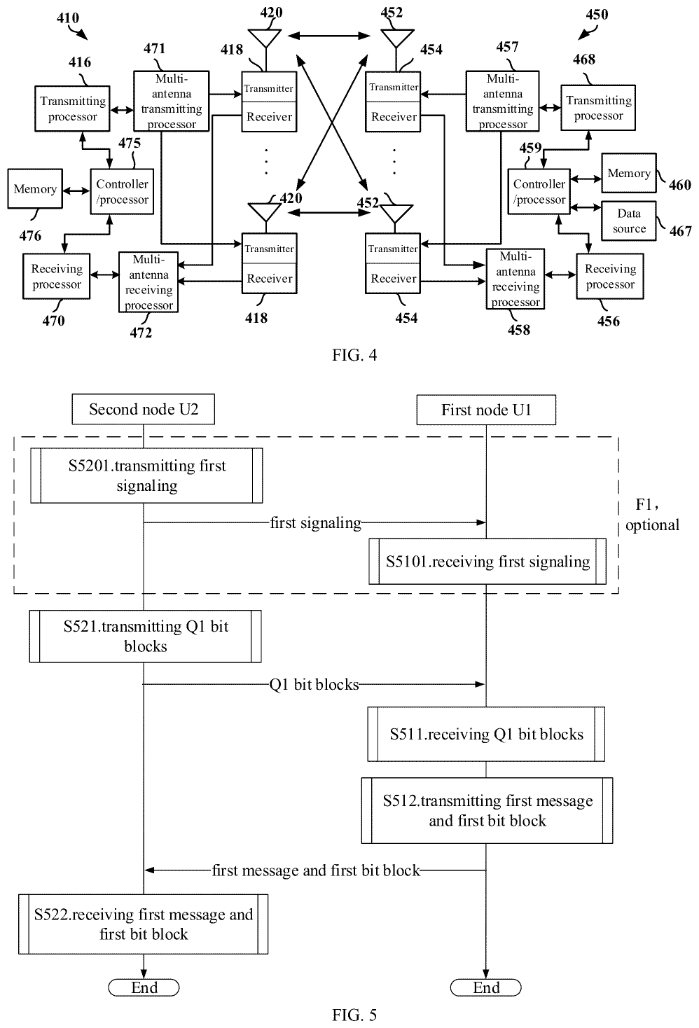

Embodiment 4 illustrates a schematic diagram of a first communication device and a second communication device according to the present application, as shown in FIG. 4. FIG. 4 is a block diagram of a first communication device 410 and a second communication device 450 in communication with each other in an access network.

The first communication device 410 comprises a controller/processor 475, a memory 476, a receiving processor 470, a transmitting processor 416, a multi-antenna receiving processor 472, a multi-antenna transmitting processor 471, a transmitter/receiver 418 and an antenna 420.

The second communication device 450 comprises a controller/processor 459, a memory 460, a data source 467, a transmitting processor 468, a receiving processor 456, a multi-antenna transmitting processor 457, a multi-antenna receiving processor 458, a transmitter/receiver 454 and an antenna 452.

In a transmission from the first communication device 410 to the second communication device 450, at the first communication device 410, a higher layer packet from a core network is provided to the controller/processor 475. The controller/processor 475 provides functions of the L2 layer. In the transmission from the first communication device 410 to the second communication device 450, the controller/processor 475 provides header compression, encryption, packet segmentation and reordering, and multiplexing between a logical channel and a transport channel, and radio resource allocation of the second communication device 450 based on various priorities. The controller/processor 475 is also in charge of a retransmission of a lost packet and a signaling to the second communication device 450. The transmitting processor 416 and the multi-antenna transmitting processor 471 perform various signal processing functions used for the L1 layer (i.e., PHY). The transmitting processor 416 performs coding and interleaving so as to ensure a Forward Error Correction (FEC) at the second communication device 450 side and the mapping to signal clusters corresponding to each modulation scheme (i.e., BPSK, QPSK, M-PSK, and M-QAM, etc.). The multi-antenna transmitting processor 471 performs digital spatial precoding, which includes precoding based on codebook and precoding based on non-codebook, and beamforming processing on encoded and modulated signals to generate one or more spatial streams. The transmitting processor 416 then maps each spatial stream into a subcarrier. The mapped symbols are multiplexed with a reference signal (i.e., pilot frequency) in time domain and/or frequency domain, and then they are assembled through Inverse Fast Fourier Transform (IFFT) to generate a physical channel carrying time-domain multicarrier symbol streams. After that the multi-antenna transmitting processor 471 performs transmission analog precoding/beamforming on the time-domain multicarrier symbol streams. Each transmitter 418 converts a baseband multicarrier symbol stream provided by the multi-antenna transmitting processor 471 into a radio frequency (RF) stream, which is later provided to different antennas 420.

In a transmission from the first communication device 410 to the second communication device 450, at the second communication device 450, each receiver 454 receives a signal via a corresponding antenna 452. Each receiver 454 recovers information modulated to the RF carrier, and converts the radio frequency stream into a baseband multicarrier symbol stream to be provided to the receiving processor 456. The receiving processor 456 and the multi-antenna receiving processor 458 perform signal processing functions of the L1 layer. The multi-antenna receiving processor 458 performs reception analog precoding/beamforming on a baseband multicarrier symbol stream provided by the receiver 454. The receiving processor 456 converts baseband multicarrier symbol streams which have gone through reception analog precoding/beamforming operations from time domain to frequency domain using FFT. In frequency domain, physical layer data signals and reference signals are de-multiplexed by the receiving processor 456, where the reference signals are used for channel estimation while data signals are processed in the multi-antenna receiving processor 458 by multi-antenna detection to recover any spatial stream targeting the second communication device 450. Symbols on each spatial stream are demodulated and recovered in the receiving processor 456 to generate a soft decision. Then the receiving processor 456 decodes and de-interleaves the soft decision to recover the higher-layer data and control signal transmitted by the first communication device 410 on the physical channel. Next, the higher-layer data and control signal are provided to the controller/processor 459. The controller/processor 459 provides functions of the L2 layer. The controller/processor 459 can be associated with a memory 460 that stores program code and data. The memory 460 can be called a computer readable medium. In the transmission from the first communication device 410 to the second communication device 450, the controller/processor 459 provides demultiplexing between a transport channel and a logical channel, packet reassembling, decrypting, header decompression and control signal processing so as to recover a higher-layer packet from the core network. The higher-layer packet is later provided to all protocol layers above the L2 layer. Or various control signals can be provided to the L3 for processing.

In a transmission from the second communication device 450 to the first communication device 410, at the second communication device 450, the data source 467 is configured to provide a higher-layer packet to the controller/processor 459. The data source 467 represents all protocol layers above the L2 layer. Similar to a transmitting function of the first communication device 410 described in the transmission from the first communication node 410 to the second communication node 450, the controller/processor 459 performs header compression, encryption, packet segmentation and reordering, and multiplexing between a logical channel and a transport channel based on radio resource allocation of the first communication device 410 so as to provide the L2 layer functions used for the user plane and the control plane. The controller/processor 459 is also responsible for a retransmission of a lost packet, and a signaling to the first communication device 410. The transmitting processor 468 performs modulation and mapping, as well as channel coding, and the multi-antenna transmitting processor 457 performs digital multi-antenna spatial precoding, including precoding based on codebook and precoding based on non-codebook, and beamforming. The transmitting processor 468 then modulates generated spatial streams into multicarrier/single-carrier symbol streams. The modulated symbol streams, after being subjected to analog precoding/beamforming in the multi-antenna transmitting processor 457, are provided from the transmitter 454 to each antenna 452. Each transmitter 454 firstly converts a baseband symbol stream provided by the multi-antenna transmitting processor 457 into a radio frequency symbol stream, and then provides the radio frequency symbol stream to the antenna 452.

In a transmission from the second communication device 450 to the first communication device 410, the function of the first communication device 410 is similar to the receiving function of the second communication device 450 described in the transmission from the first communication device 410 to the second communication device 450. Each receiver 418 receives a radio frequency signal via a corresponding antenna 420, converts the received radio frequency signal into a baseband signal, and provides the baseband signal to the multi-antenna receiving processor 472 and the receiving processor 470. The receiving processor 470 and the multi-antenna receiving processor 472 jointly provide functions of the L1 layer. The controller/processor 475 provides functions of the L2 layer. The controller/processor 475 can be associated with the memory 476 that stores program code and data. The memory 476 can be called a computer readable medium. In the transmission between the second communication device 450 and the first communication device 410, the controller/processor 475 provides de-multiplexing between a transport channel and a logical channel, packet reassembling, decrypting, header decompression, control signal processing so as to recover a higher-layer packet from the second communication device (UE) 450. The higher-layer packet coming from the controller/processor 475 may be provided to the core network.

In one embodiment, the first node in the present application comprises the second communication device 450, and the second node in the present application comprises the first communication device 410.

In one subembodiment, the first node is a UE, and the second node is a UE.

In one subembodiment, the first node is a UE, and the second node is a relay node.

In one subembodiment, the first node is a relay node, and the second node is a UE.

In one subembodiment, the first node is a UE, and the second node is a base station.

In one subembodiment, the first node is a relay node, and the second node is a base station.

In one subembodiment, the second node is a UE, and the first node is a base station.

In one subembodiment, the second node is a relay node, and the first node is a base station.

In one subembodiment, the second communication device 450 comprises: at least one controller/processor; the at least one controller/processor is in charge of HARQ operation.

In one subembodiment, the first communication device 410 comprises: at least one controller/processor; the at least one controller/processor is in charge of HARQ operation.

In one subembodiment, the first communication device 410 comprises: at least one controller/processor; the at least one controller/processor is in charge of error detections using ACK and/or NACK protocols to support HARQ operation.

In one embodiment, the second communication device 450 comprises at least one processor and at least one memory, the at least one memory comprises computer program codes; the at least one memory and the computer program codes are configured to be used in collaboration with the at least one processor. The second communication device 450 at least: receives Q1 bit blocks, Q1 being a positive integer greater than 1; and transmits a first message and a first bit block; herein, the first message is used for indicating an associated bit block set of each bit in the first bit block, and the associated bit block set of each bit in the first bit block comprises at least one bit block among the Q1 bit blocks, and each bit in the first bit block is used for indicating whether a corresponding associated bit block set is correctly decoded.

In one subembodiment, the second communication device 450 corresponds to the first node in the present application.

In one embodiment, the second communication device 450 comprises a memory that stores a computer readable instruction program, the computer readable instruction program generates actions when executed by at least one processor, which include: receiving Q1 bit blocks, Q1 being a positive integer greater than 1; and transmitting a first message and a first bit block; herein, the first message is used for indicating an associated bit block set of each bit in the first bit block, and the associated bit block set of each bit in the first bit block comprises at least one bit block among the Q1 bit blocks, and each bit in the first bit block is used for indicating whether a corresponding associated bit block set is correctly decoded.

In one subembodiment, the second communication device 450 corresponds to the first node in the present application.

In one embodiment, the first communication device 410 comprises at least one processor and at least one memory, the at least one memory comprises computer program codes; the at least one memory and the computer program codes are configured to be used in collaboration with the at least one processor. The first communication device 410 at least: transmits Q1 bit blocks, Q1 being a positive integer greater than 1; and receives a first message and a first bit block; herein, the first message is used for indicating an associated bit block set of each bit in the first bit block, and the associated bit block set of each bit in the first bit block comprises at least one bit block among the Q1 bit blocks, and each bit in the first bit block is used for indicating whether a corresponding associated bit block set is correctly decoded.

In one subembodiment, the first communication device 410 corresponds to the second node in the present application.

In one embodiment, the first communication device 410 comprises a memory that stores a computer readable instruction program, the computer readable instruction program generates actions when executed by at least one processor, which include: transmitting Q1 bit blocks, Q1 being a positive integer greater than 1; and receiving a first message and a first bit block; herein, the first message is used for indicating an associated bit block set of each bit in the first bit block, and the associated bit block set of each bit in the first bit block comprises at least one bit block among the Q1 bit blocks, and each bit in the first bit block is used for indicating whether a corresponding associated bit block set is correctly decoded.

In one subembodiment, the first communication device 410 corresponds to the second node in the present application.

In one embodiment, at least one of the antenna 452, the receiver 454, the multi-antenna receiving processor 458, the receiving processor 456, the controller/processor 459, the memory 460, or the data source 467 is used for receiving the Q1 bit blocks in the present application.

In one embodiment, at least one of the antenna 420, the transmitter 418, the multi-antenna transmitting processor 471, the transmitting processor 416, the controller/processor 475 or the memory 476 is used for transmitting the Q1 bit blocks in the present application.

In one embodiment, at least one of the antenna 452, the receiver 454, the multi-antenna receiving processor 458, the receiving processor 456, the controller/processor 459, the memory 460, or the data source 467 is used for receiving the first signaling in the present application.

In one embodiment, at least one of the antenna 420, the transmitter 418, the multi-antenna transmitting processor 471, the transmitting processor 416, the controller/processor 475 or the memory 476 is used for transmitting the first signaling in the present application.

In one embodiment, at least one of the antenna 452, the transmitter 454, the multi-antenna transmitting processor 458, the transmitting processor 468, the controller/processor 459, the memory 460, or the data source 467 is used for transmitting the first message in the present application and the first bit block in the present application.

In one embodiment, at least one of the antenna 420, the receiver 418, the multi-antenna receiving processor 472, the receiving processor 470, the controller/processor 475 or the memory 476 is used for receiving the first message in the present application and the first bit block in the present application.

### Embodiment 5

Embodiment 5 illustrates a flowchart of signal transmission according to one embodiment of the present application, as shown in FIG. 5. In FIG. 5, a first node U1 and a second node U2 are in communications via an air interface. In FIG. 5, steps marked by the dotted-line frame box F1 are optional.

The first node U1 receives a first signaling in step S5101; receives Q1 bit blocks in step S511; and transmits a first message and a first bit block in step S512.

The second node U2 transmits a first signaling in step S5201; transmits Q1 bit blocks in step S521; and receives a first message and a first bit block in step S522.

In Embodiment 5, Q1 is a positive integer greater than 1; the first message is used for indicating an associated bit block set of each bit in the first bit block, and the associated bit block set of each bit in the first bit block comprises at least one bit block among the Q1 bit blocks, and each bit in the first bit block is used for indicating whether a corresponding associated bit block set is correctly decoded; the first bit block consists of Q2 bit(s), Q2 being a positive integer less than Q1; the associated bit block set of each bit of the Q2 bits consists of one or multiple bit blocks among the Q1 bit blocks; any of the Q1 bit blocks is associated with only one bit of the Q2 bit(s); the first signaling is used for indicating L1 association methods, and the first message is used for indicating a first association method among the L1 association methods, the first association method being used to determine bit block(s) associated with each bit in the first bit block among the Q1 bit blocks; L1 is a positive integer greater than 1; the first message and the first bit block are transmitted on a same physical layer channel, or, the first message and the first bit block are transmitted respectively on two physical layer channels.

In one subembodiment of Embodiment 5, any of the Q1 bit blocks belongs to only one bit block group of Q3 bit block groups; any bit in the first bit block belongs to only one bit sub-block of Q3 bit sub-blocks; the Q3 bit sub-blocks respectively indicate whether bit blocks in the Q3 bit block groups are correctly decoded, the Q3 bit sub-blocks respectively corresponding to the Q3 bit block groups; for any of the Q3 bit sub-blocks, the first message is used for indicating an associated bit block set of each bit from a corresponding bit block group; Q3 is a positive integer greater than 1 and less than Q1.

In one subembodiment of Embodiment 5, a second bit block consists of Q4 bits, and each bit block among the Q1 bit blocks corresponds to one bit among the Q4 bits, Q4 being a positive integer greater than 1; the first message is used for indicating an associated bit set of each bit in the first bit block, the associated bit set of each bit in the first bit block comprising at least one bit among the Q4 bits; an associated bit block set of a given bit in the first bit block comprises all bit block(s) among the Q1 bit blocks that corresponds/correspond to any bit in an associated bit set of the given bit in the first bit block.

In one embodiment, the first node U1 is the first node in the present application.

In one embodiment, the second node U2 is the second node in the present application.

In one embodiment, the first node U1 is a UE.

In one embodiment, the first node U1 is a base station.

In one embodiment, the second node U2 is a base station.

In one embodiment, the second node U2 is a UE.

In one embodiment, an air interface between the second node U2 and the first node U1 is a Uu interface.

In one embodiment, an air interface between the second node U2 and the first node U1 includes a cellular link.

In one embodiment, an air interface between the second node U2 and the first node U1 is a PC5 interface.

In one embodiment, an air interface between the second node U2 and the first node U1 includes a sidelink.

In one embodiment, an air interface between the second node U2 and the first node U1 includes a radio interface between a base station and a UE.

In one embodiment, an air interface between the second node U2 and the first node U1 includes a radio interface between a UE and another UE.

In one embodiment, transmission of the first message is no later than transmission of the first bit block.

In one embodiment, Q2 is greater than 1.

In one embodiment, Q2 is default or configurable.

In one embodiment, steps marked by the dotted-line box F1 exist.

In one embodiment, steps marked by the dotted-line box F1 do not exist.

### Embodiment 6

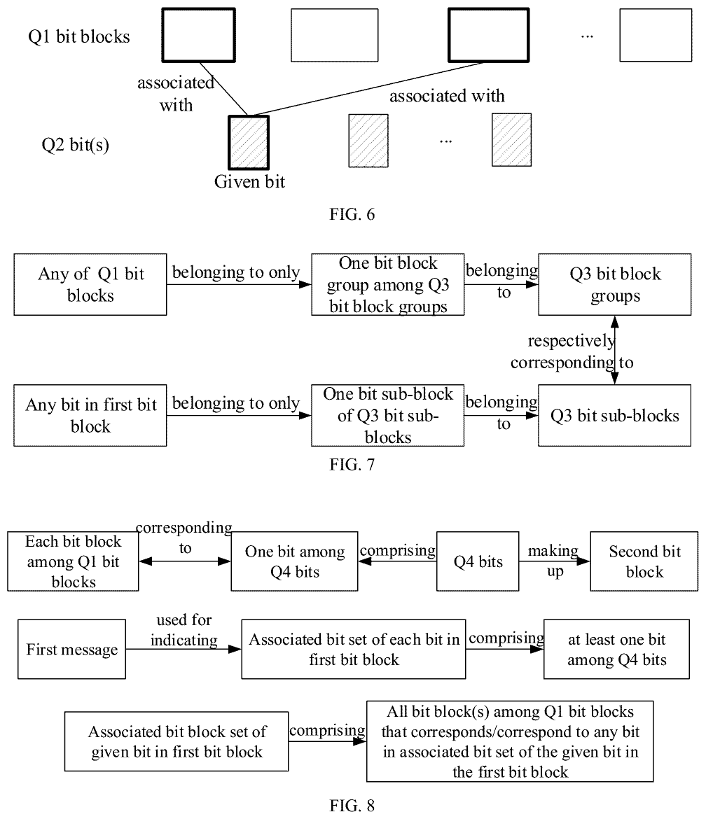

Embodiment 6 illustrates a schematic diagram of a relationship between a given bit of Q2 bit(s) and Q1 bit blocks according to one embodiment of the present application, as shown in FIG. 6. In FIG. 6, a slash-filled box represents one bit of Q2 bit(s), and the slash-filled box framed with bold lines represents a given bit of the Q2 bit(s); a blank box represents one bit block of Q1 bit blocks, and the blank box framed with bold lines represents a bit block in an associated bit block set of the given bit of the Q2 bit(s).

In Embodiment 6, the first bit block in the present application consists of Q2 bit(s); an associated bit block set of a given bit of the Q2 bit(s) consists of one or more bit blocks among the Q1 bit blocks.

In one embodiment, the given bit of the Q2 bit(s) is any bit of the Q2 bit(s).

In one embodiment, any of the Q1 bit blocks is associated with at least one bit of the Q2 bit(s).

In one embodiment, any of the Q1 bit blocks is associated with only one bit of the Q2 bit(s).

In one embodiment, an associated bit block set of each bit of the Q2 bit(s) consists of one or multiple bit blocks among the Q1 bit blocks.

### Embodiment 7

Embodiment 7 illustrates a schematic diagram of relations among Q1 bit blocks, Q3 bit block groups, a first bit block and Q3 bit sub-blocks according to one embodiment of the present application, as shown in FIG. 7.

In Embodiment 7, any of the Q1 bit blocks in the present application belongs to only one bit block group among the Q3 bit block groups in the present application; any bit in the first bit block in the present application belongs to only one bit sub-block of Q3 bit sub-blocks in the present application; the Q3 bit sub-blocks respectively indicate whether bit blocks in the Q3 bit block groups are correctly decoded, the Q3 bit sub-blocks respectively corresponding to the Q3 bit block groups.

In one embodiment, for any of the Q3 bit sub-blocks, the first message in the present application is used for indicating an associated bit block set of each bit from a corresponding bit block group; Q3 is a positive integer greater than 1 and less than Q1.

In one embodiment, Q3 is default or configurable.

In one embodiment, Q3 is no greater than 1706.

In one embodiment, Q3 is no greater than 65536.

In one embodiment, Q1 is a positive integral multiple of Q3.

In one embodiment, Q1 is not a positive integral multiple of Q3.

In one embodiment, any bit block group among the Q3 bit block groups belongs to the Q1 bit blocks.

In one embodiment, any bit sub-block among the Q3 bit sub-blocks belongs to the first bit block.

In one embodiment, which bit block group among the Q3 bit block groups a bit block among the Q1 bit blocks belongs to is determined based on a default grouping rule or a grouping rule configured by a higher layer signaling.

In one embodiment, Q1 is a positive integral multiple of Q3; an i-th bit block group of the Q3 bit block groups comprises a (Q1/Q3×(i−1)+1)-th bit block through a (Q1/Q3×i)-th bit block among the Q1 bit blocks; i is any positive integer no greater than Q3.

In one embodiment, Q1 is a positive integral multiple of Q3; an i-th bit block group of the Q3 bit block groups comprises an i-th bit block, a (Q3+i)-th bit block, . . . and a ((Q1/Q3-1)×Q3+i)-th bit block among the Q1 bit blocks; i is any positive integer no greater than Q3.

In one embodiment, which bit block group among the Q3 bit block groups a bit block among the Q1 bit blocks belongs to is determined by means of looking up in tables.

In one embodiment, any bit sub-block among the Q3 bit sub-blocks comprises at least two bits.

In one embodiment, a size of any bit sub-block among the Q3 bit sub-blocks is default or configurable.

In one embodiment, the Q3 bit sub-blocks are of identical sizes.

In one embodiment, there are two bit sub-blocks of different sizes among the Q3 bit sub-blocks.

In one embodiment, any bit block group among the Q3 bit block groups comprises at least two bit blocks.

In one embodiment, numbers of bit blocks comprised by any two bit block groups among the Q3 bit block groups are identical.

In one embodiment, a number of bit blocks comprised by one bit block group among the Q3 bit block groups is different from a number of bit blocks comprised by another bit block group among the Q3 bit block groups.

In one embodiment, for any of the Q3 bit sub-blocks, the first message is used for explicitly indicating an associated bit block set of each bit from a corresponding bit block group.

In one embodiment, for any of the Q3 bit sub-blocks, the first message is used for implicitly indicating an associated bit block set of each bit from a corresponding bit block group.

In one embodiment, any of the Q1 bit blocks belongs to only one bit block group of Q3 bit block group(s); any bit in the first bit block belongs to only one bit sub-block of Q3 bit sub-blocks; the Q3 bit sub-blocks respectively indicate whether bit blocks in the Q3 bit block groups are correctly decoded, the Q3 bit sub-blocks respectively corresponding to the Q3 bit block groups; for any of the Q3 bit sub-blocks, the first association method in the present application is used for determining an associated bit block set of each bit from a corresponding bit block group.

In one subembodiment, the L1 association methods are respectively L1 different mapping relations; an associated bit block set of a given bit in a given bit sub-block of the Q3 bit sub-blocks comprises all bit block(s) mapped to the given bit in the given bit sub-block of the Q3 bit sub-blocks based on the first association method in a bit block group corresponding to the given bit sub-block of the Q3 bit sub-blocks.

In one subembodiment, the L1 association methods are respectively L1 different methods of mapping between multiple bit blocks and multiple bits; an associated bit block set of a given bit in a given bit sub-block of the Q3 bit sub-blocks comprises all bit block(s) mapped to the given bit in the given bit sub-block of the Q3 bit sub-blocks based on the first association method in a bit block group corresponding to the given bit sub-block of the Q3 bit sub-blocks.

In one subembodiment, the L1 association methods are respectively L1 different methods of mapping between first-type bit blocks and first-type bits; each bit block in the Q3 bit block groups is the first-type bit block, and each bit in the Q3 bit sub-blocks is the first-type bit, an associated bit block set of a given bit in a given bit sub-block of the Q3 bit sub-blocks comprises all bit block(s) mapped to the given bit in the given bit sub-block of the Q3 bit sub-blocks based on the first association method in a bit block group corresponding to the given bit sub-block of the Q3 bit sub-blocks.

In one subembodiment, the L1 association methods respectively correspond to L1 different lookup tables; an associated bit block set of any bit in any bit sub-block among the Q3 bit sub-blocks comprises all bit block(s) associated with the any bit in the any bit sub-block among the Q3 bit sub-blocks in a bit block group corresponding to the any bit sub-block among the Q3 bit sub-blocks determined by looking up in a lookup table corresponding to the first association method.

In one embodiment, the given bit sub-block of the Q3 bit sub-blocks is any bit sub-block among the Q3 bit sub-blocks.

In one embodiment, a given bit in a given bit sub-block of the Q3 bit sub-blocks is any bit in the given bit sub-block of the Q3 bit sub-blocks.

In one embodiment, the statement in the present application that the Q3 bit sub-blocks respectively indicate whether bit blocks in the Q3 bit block groups are correctly decoded means that: for any bit sub-block among the Q3 bit sub-blocks, each bit is used for indicating whether one bit block in a corresponding bit block group is correctly decoded or whether multiple bit blocks in a corresponding bit block group are all correctly decoded.

In one embodiment, the statement in the present application that the Q3 bit sub-blocks respectively indicate whether bit blocks in the Q3 bit block groups are correctly decoded means that: for any bit sub-block among the Q3 bit sub-blocks, each bit is used for indicating whether bit blocks in a corresponding associated bit block set are all correctly decoded.

In one embodiment, the statement in the present application that the Q3 bit sub-blocks respectively indicate whether bit blocks in the Q3 bit block groups are correctly decoded means that: for any bit sub-block among the Q3 bit sub-blocks, each bit is used for indicating whether one bit block in a corresponding bit block group is correctly decoded or whether at least one bit block of multiple bit blocks in a corresponding bit block group is correctly decoded.

In one embodiment, the statement in the present application that the Q3 bit sub-blocks respectively indicate whether bit blocks in the Q3 bit block groups are correctly decoded means that: for any bit sub-block among the Q3 bit sub-blocks, each bit is used for indicating whether there is at least one bit block in a corresponding associated bit block set being correctly decoded.

### Embodiment 8

Embodiment 8 illustrates a schematic diagram of relations among Q1 bit blocks, a second bit block, Q4 bits, a first bit block and a first message according to one embodiment of the present application, as shown in FIG. 8.

In Embodiment 8, the second bit block in the present application consists of the Q4 bits in the present application, and each bit block among the Q1 bit blocks in the present application corresponds to one bit among the Q4 bits, Q4 being a positive integer greater than 1; the first message in the present application is used for indicating an associated bit set of each bit in the first bit block in the present application, the associated bit set of each bit in the first bit block comprising at least one bit among the Q4 bits; an associated bit block set of a given bit in the first bit block comprises all bit block(s) among the Q1 bit blocks that corresponds/correspond to any bit in an associated bit set of the given bit in the first bit block.

In Embodiment 8, the given bit in the first bit block is any bit in the first bit block.

In one embodiment, the second bit block is obtained by calculation performed by the first node.

In one embodiment, the second bit block comprises multiple HARQ-ACK information bits.

In one embodiment, each bit comprised by the second bit block is a HARQ-ACK information bit.

In one embodiment, the second bit block is a HARQ-ACK codebook.

In one embodiment, the second bit block belongs to a HARQ-ACK codebook.

In one embodiment, Q4 is no greater than 1706.

In one embodiment, Q4 is no greater than 65536.

In one embodiment, Q4 is equal to Q1, and the Q1 bit blocks respectively correspond to the Q4 bits.

In one embodiment, there exists at least one bit among the Q4 bits that does not correspond to any of the Q1 bit blocks.

In one embodiment, in the present application, the given bit in the first bit block is any bit in the first bit block.

In one embodiment, any bit in the associated bit set of each bit in the first bit block is one of the Q4 bits.

In one embodiment, each bit block among the Q1 bit blocks corresponds to only one bit among the Q4 bits.

In one embodiment, that a bit block among the Q1 bit blocks corresponds to a bit in an associated bit set of a bit in the first bit block means that: the bit block among the Q1 bit blocks corresponds to a bit among the Q4 bits, and the bit among the Q4 bits is a bit in the associated bit set of the bit in the first bit block.

In one embodiment, a bit block among the Q1 bit blocks corresponds to a bit among the Q4 bits means that: the bit among the Q4 bits is used for indicating whether the bit block among the Q1 bit blocks is correctly decoded.

In one embodiment, a bit block among the Q1 bit blocks corresponds to a bit among the Q4 bits means that: the bit block among the Q1 bit blocks is mapped to the bit among the Q4 bits based on a default or configured mapping rule.

In one embodiment, a bit block among the Q1 bit blocks corresponds to a bit among the Q4 bits means that: the bit block among the Q1 bit blocks is corresponding to the bit among the Q4 bits based on a default or configured lookup table.

In one embodiment, each of bit(s) in an associated bit set of each bit in the first bit block is the bit among the Q4 bits.

In one embodiment, the first association method in the present application is used to determine an associated bit set of each bit in the first bit block.

In one embodiment, the first association method in the present application is used to determine an associated bit of each bit in the first bit block among the Q4 bits.

In one embodiment, the L1 association methods in the present application are respectively L1 different mapping relations; an associated bit set of a given bit in the first bit block comprises all bits mapped to the given bit in the first bit block based on the first association method in the present application among the Q4 bits.

In one embodiment, the L1 association methods in the present application are respectively L1 different methods of mapping between bits; an associated bit set of a given bit in the first bit block comprises all bits mapped to the given bit in the first bit block based on the first association method in the present application among the Q4 bits.

In one embodiment, the L1 association methods in the present application respectively correspond to L1 different lookup tables; an associated bit set of a given bit in the first bit block comprises all bits associated with the given bit in the first bit block among the Q4 bits determined by looking up in a lookup table corresponding to the first association method in the present application.

In one embodiment, the first message is used for explicitly indicating an associated bit set of each bit in the first bit block.

In one embodiment, the first message is used for indicating an index of each bit in an associated bit set of each bit in the first bit block among the Q4 bits.

In one embodiment, the first message is used for implicitly indicating an associated bit set of each bit in the first bit block.

In one embodiment, the statement in the present application that an associated bit block set of a given bit in the first bit block comprises all bit block(s) among the Q1 bit blocks that corresponds/correspond to any bit in the associated bit set of the given bit in the first bit block means that: an associated bit block set of a given bit in the first bit block comprises all bit block(s) among the Q1 bit blocks that corresponds/correspond to at least one bit in the associated bit set of the given bit in the first bit block.

### Embodiment 9

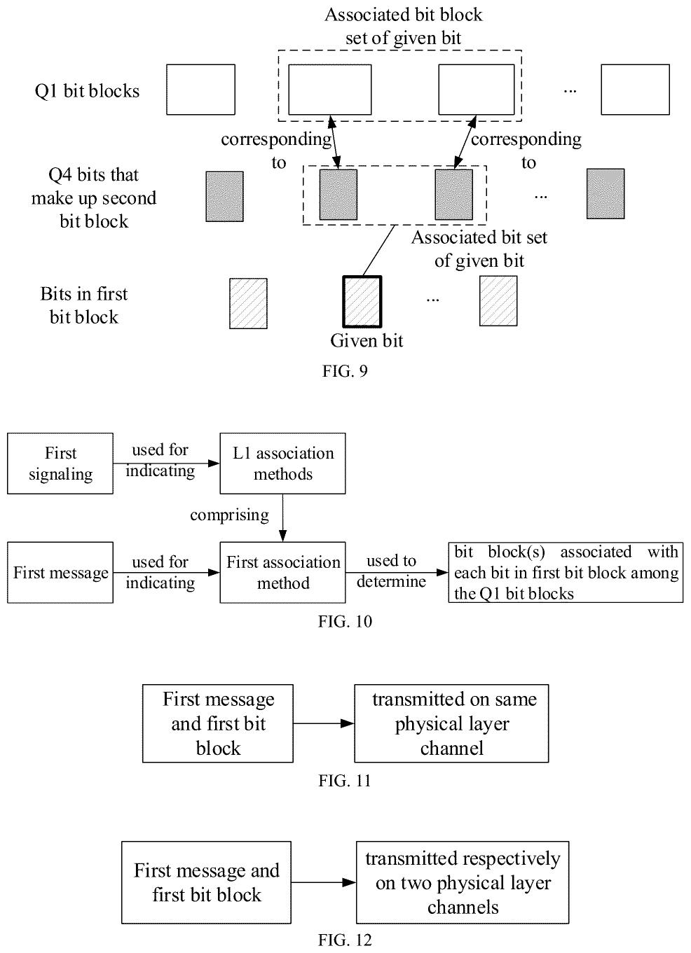

Embodiment 9 illustrates a schematic diagram of relations among a given bit in a first bit block, Q1 bit blocks and Q4 bits according to one embodiment of the present application, as shown in FIG. 9. In FIG. 9, a slash-filled box represents a bit in a first bit block, and the slash-filled box framed with bold lines represents a given bit in the first bit block; a box in grey represents one bit among Q4 bits that form a second bit block, and the boxes in grey marked by the broken-line box represent an associated bit set of the given bit in the first bit block; a blank box represents one of Q1 bit blocks, and the blank boxes marked by the broken-line box represent an associated bit block set of the given bit in the first bit block.

In Embodiment 9, each bit block among the Q1 bit blocks corresponds to one bit among the Q4 bits; the first message in the present application is used for indicating an associated bit set of each bit in the first bit block; an associated bit block set of the given bit in the first bit block comprises all bit block(s) among the Q1 bit blocks that corresponds/correspond to any bit in an associated bit set of the given bit in the first bit block.

In one embodiment, the given bit in the first bit block is any bit in the first bit block.

### Embodiment 10

Embodiment 10 illustrates a schematic diagram of relations among a first signaling, L1 association methods, a first message, a first association method and bit block(s) associated with each bit in the first bit block among Q1 bit blocks according to one embodiment of the present application, as shown in FIG. 10.

In Embodiment 10, the first signaling in the present application is used for indicating the L1 association methods in the present application, and the first message in the present application is used for indicating the first association method in the present application among the L1 association methods, the first association method being used to determine bit block(s) associated with each bit in the first bit block among the Q1 bit blocks; L1 is a positive integer greater than 1.

In one embodiment, the first signaling is an RRC signaling.

In one embodiment, the first signaling comprises one or more fields in an RRC signaling.

In one embodiment, the first signaling comprises one Information Element (IE).

In one embodiment, the first signaling is a MAC CE signaling.

In one embodiment, the first signaling comprises one or more fields in a MAC CE signaling.

In one embodiment, the first signaling is a higher layer signaling.

In one embodiment, the first signaling is a DownLink Grant Signaling.

In one embodiment, the first signaling is used for explicitly indicating the L1 association methods.

In one embodiment, the first signaling is used for implicitly indicating the L1 association methods.

In one embodiment, the first signaling is used for indicating the L1 association methods by means of configuration parameters.

In one embodiment, the L1 association methods are respectively L1 different methods of mapping between bit block(s) and bit(s).

In one embodiment, the L1 association methods are respectively L1 different methods of mapping between multiple bit blocks and multiple bits.

In one embodiment, the L1 association methods respectively correspond to L1 different lookup tables.

In one embodiment, the first message is used for explicitly indicating the first association method among the L1 association methods.

In one embodiment, the first message is used for implicitly indicating the first association method among the L1 association methods.

In one embodiment, the first message is used for indicating an index of the first association method among the L1 association methods.

In one embodiment, the L1 association methods are respectively L1 different mapping relations; an associated bit block set of a given bit in the first bit block comprises all bit block(s) mapped to the given bit in the first bit block based on the first association method among the Q1 bit blocks.

In one embodiment, the L1 association methods are respectively L1 different methods of mapping between multiple bit blocks and multiple bits; an associated bit block set of a given bit in the first bit block comprises all bit block(s) mapped to the given bit in the first bit block based on the first association method among the Q1 bit blocks.

In one embodiment, the L1 association methods are respectively L1 different methods of mapping between first-type bit blocks and first-type bits; each of the Q1 bit blocks is the first-type bit block, and any bit in the first bit block is a said first-type bit, where an associated bit block set of a given bit in the first bit block comprises all bit block(s) mapped to the given bit in the first bit block based on the first association method among the Q1 bit blocks. In one embodiment, a said first-type bit block in the present application is a TB.

In one embodiment, a said first-type bit block in the present application is a CBG.

In one embodiment, a said first-type bit block in the present application is a TB or a CBG.

In one embodiment, a said first-type bit block in the present application is a bit block transmitted in a PD SCH.

In one embodiment, a said first-type bit block in the present application is a bit block made up of at least one TB.

In one embodiment, a said first-type bit block in the present application is a bit block made up of at least one CBG.

In one embodiment, a TB is a said first-type bit block in the present application.

In one embodiment, a CBG is a said first-type bit block in the present application.

In one embodiment, a DCI format for indicating Semi-persistent scheduling (SPS) Physical Downlink Shared CHannel (PDSCH) release is a said first-type bit block in the present application.

In one embodiment, a said first-type bit in the present application is a HARQ-ACK information bit.

In one embodiment, a bit indicating ACK or NACK is a said first-type bit in the present application.

In one embodiment, a said first-type bit in the present application is an Uplink control information (UCI) bit.

In one embodiment, a said first-type bit in the present application is a Sidelink Control Information (SCI) bit.

In one embodiment, the L1 association methods respectively correspond to L1 different lookup tables; an associated bit block set of a given bit in the first bit block comprises all bit block(s) associated with the given bit in the first bit block among the Q1 bit blocks determined by looking up in a lookup table corresponding to the first association method.

In one embodiment, the L1 association methods are respectively L1 different mapping relations; an associated bit set of a given bit in the first bit block comprises all bits mapped to the given bit in the first bit block based on the first association method among the Q4 bits in the present application.

In one embodiment, the L1 association methods are respectively L1 different methods of mapping between bits; an associated bit set of a given bit in the first bit block comprises all bits mapped to the given bit in the first bit block based on the first association method among the Q4 bits in the present application.

In one embodiment, the L1 association methods respectively correspond to L1 different lookup tables; an associated bit set of a given bit in the first bit block comprises all bits associated with the given bit in the first bit block among the Q4 bits in the present application determined by looking up in a lookup table corresponding to the first association method.

### Embodiment 11

Embodiment 11 illustrates a schematic diagram of a method of transmitting a first message and a first bit block according to one embodiment of the present application, as shown in FIG. 11.

In Embodiment 11, the first message in the present application and the first bit block in the present application are transmitted on a same physical layer channel.

In one embodiment, before being transmitted on the same physical layer channel, a bit sequence formed by the first message and the first bit block has been through at least Modulation and Mapping to Physical Resources.

In one embodiment, before being transmitted on the same physical layer channel, a bit sequence formed by the first message and the first bit block has been through at least Scrambling, Modulation and Mapping to Physical Resources.

In one embodiment, before being transmitted on the same physical layer channel, a bit sequence formed by the first message and the first bit block has been through at least Channel Coding, Rate Matching, Scrambling, Modulation and Mapping to Physical Resources.

In one embodiment, before being transmitted on the same physical layer channel, a bit sequence formed by the first message and the first bit block has been through at least CRC attachment, Channel Coding, Rate Matching, Scrambling, Modulation and Mapping to Physical Resources.

In one embodiment, before being transmitted on the same physical layer channel, a bit sequence formed by the first message and the first bit block has been through at least CRC attachment, Code Block Segmentation, Code Block CRC attachment, Channel Coding, Rate Matching, Code Block Concatenation, Scrambling, Modulation and Mapping to Physical Resources.

In one embodiment, an output by a bit sequence that includes the first message and the first bit block through part or all of CRC attachment, Code Block Segmentation, Code Block CRC attachment, Channel Coding, Rate Matching, Code Block Concatenation, Scrambling, Modulation, Spreading, Layer Mapping, Precoding, Mapping to Physical Resources, Multicarrier Symbol Generation, and Modulation and Upconversion is transmitted on the same physical layer channel.

In one embodiment, an output by the first message through part or all of CRC attachment, Code Block Segmentation, Code Block CRC attachment, Channel Coding, Rate Matching, Code Block Concatenation, Scrambling, Modulation, Spreading, Layer Mapping, Precoding, Mapping to Physical Resources, Multicarrier Symbol Generation, and Modulation and Upconversion and an output by the first bit block through part or all of CRC attachment, Code Block Segmentation, Code Block CRC attachment, Channel Coding, Rate Matching, Code Block Concatenation, Scrambling, Modulation, Spreading, Layer Mapping, Precoding, Mapping to Physical Resources, Multicarrier Symbol Generation, and Modulation and Upconversion are transmitted together on the same physical layer channel.

In one embodiment, the same physical layer channel is a Physical Uplink Shared CHannel (PUSCH).

In one embodiment, the same physical layer channel is a Physical Uplink Control CHannel (PUCCH).

In one embodiment, the same physical layer channel is a sidelink physical layer channel.

### Embodiment 12

Embodiment 12 illustrates a schematic diagram of a method of transmitting a first message and a first bit block according to one embodiment of the present application, as shown in FIG. 12.

In Embodiment 12, the first message in the present application and the first bit block in the present application are transmitted respectively on two physical layer channels.

In one embodiment, the first node is a UE, and the two physical layer channels are respectively a PUSCH and a PUCCH.

In one embodiment, the first node is a UE, and the two physical layer channels are respectively a PUCCH and a PUSCH.

In one embodiment, the first node is a UE, and the two physical layer channels are respectively two different PUSCHs.

In one embodiment, the first node is a UE, and the two physical layer channels are respectively two different PUCCHs.

In one embodiment, the first node is a UE, and the two physical layer channels are respectively two different sidelink physical layer channels.

In one embodiment, an output by the first message through part or all of CRC attachment, Code Block Segmentation, Code Block CRC attachment, Channel Coding, Rate Matching, Code Block Concatenation, Scrambling, Modulation, Spreading, Layer Mapping, Precoding, Mapping to Physical Resources, Multicarrier Symbol Generation, and Modulation and Upconversion and an output by the first bit block through part or all of CRC attachment, Code Block Segmentation, Code Block CRC attachment, Channel Coding, Rate Matching, Code Block Concatenation, Scrambling, Modulation, Spreading, Layer Mapping, Precoding, Mapping to Physical Resources, Multicarrier Symbol Generation, and Modulation and Upconversion are transmitted respectively on the two physical layer channels.

In one embodiment, before being transmitted on one of the two physical layer channels, the first message has been through at least Modulation and Mapping to Physical Resources.

In one embodiment, before being transmitted on one of the two physical layer channels, the first message has been through at least Scrambling, Modulation and Mapping to Physical Resources.

In one embodiment, before being transmitted on one of the two physical layer channels, the first message has been through at least Channel Coding, Rate Matching, Scrambling, Modulation and Mapping to Physical Resources.

In one embodiment, before being transmitted on one of the two physical layer channels, the first message has been through at least CRC attachment, Channel Coding, Rate Matching, Scrambling, Modulation and Mapping to Physical Resources.

In one embodiment, before being transmitted on one of the two physical layer channels, the first message has been through at least CRC attachment, Code Block Segmentation, Code Block CRC attachment, Channel Coding, Rate Matching, Code Block Concatenation, Scrambling, Modulation and Mapping to Physical Resources.

In one embodiment, before being transmitted on one of the two physical layer channels, the first bit block has been through at least Modulation and Mapping to Physical Resources.

In one embodiment, before being transmitted on one of the two physical layer channels, the first bit block has been through at least Scrambling, Modulation and Mapping to Physical Resources.

In one embodiment, before being transmitted on one of the two physical layer channels, the first bit block has been through at least Channel Coding, Rate Matching, Scrambling, Modulation and Mapping to Physical Resources.

In one embodiment, before being transmitted on one of the two physical layer channels, the first bit block has been through at least CRC attachment, Channel Coding, Rate Matching, Scrambling, Modulation and Mapping to Physical Resources.

In one embodiment, before being transmitted on one of the two physical layer channels, the first bit block has been through at least CRC attachment, Code Block Segmentation, Code Block CRC attachment, Channel Coding, Rate Matching, Code Block Concatenation, Scrambling, Modulation and Mapping to Physical Resources.

### Embodiment 13

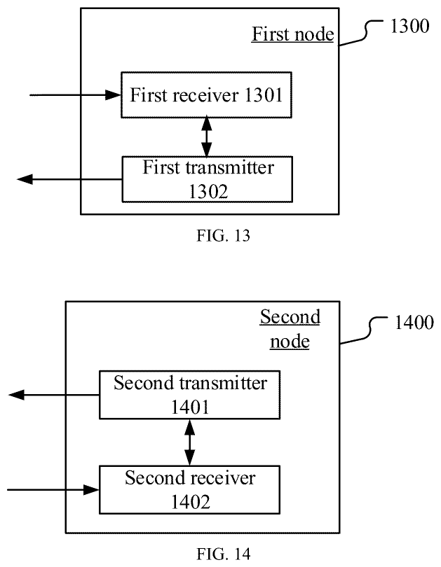

Embodiment 13 illustrates a structure block diagram a processing device in a first node according to one embodiment of the present application, as shown in FIG. 13. In FIG. 13, a processing device 1300 in a first node comprises a first receiver 1301 and a first transmitter 1302.

In one embodiment, the first node 1300 is a UE.

In one embodiment, the first node 1300 is a relay node.

In one embodiment, the first node 1300 is vehicle-mounted communication equipment.

In one embodiment, the first node 1300 is a UE supporting V2X communications.

In one embodiment, the first node 1300 is a relay node supporting V2X communications.

In one embodiment, the first receiver 1301 comprises at least one of the antenna 452, the receiver 454, the multi-antenna receiving processor 458, the receiving processor 456, the controller/processor 459, the memory 460 or the data source 467 in FIG. 4 of the present application.

In one embodiment, the first receiver 1301 comprises at least the first five of the antenna 452, the receiver 454, the multi-antenna receiving processor 458, the receiving processor 456, the controller/processor 459, the memory 460 and the data source 467 in FIG. 4 of the present application.

In one embodiment, the first receiver 1301 comprises at least the first four of the antenna 452, the receiver 454, the multi-antenna receiving processor 458, the receiving processor 456, the controller/processor 459, the memory 460 and the data source 467 in FIG. 4 of the present application.

In one embodiment, the first receiver 1301 comprises at least the first three of the antenna 452, the receiver 454, the multi-antenna receiving processor 458, the receiving processor 456, the controller/processor 459, the memory 460 and the data source 467 in FIG. 4 of the present application.

In one embodiment, the first receiver 1301 comprises at least the first two of the antenna 452, the receiver 454, the multi-antenna receiving processor 458, the receiving processor 456, the controller/processor 459, the memory 460 and the data source 467 in FIG. 4 of the present application.

In one embodiment, the first transmitter 1302 comprises at least one of the antenna 452, the transmitter 454, the multi-antenna transmitting processor 457, the transmitting processor 468, the controller/processor 459, the memory 460 or the data source 467 in FIG. 4 of the present application.

In one embodiment, the first transmitter 1302 comprises at least the first five of the antenna 452, the transmitter 454, the multi-antenna transmitting processor 457, the transmitting processor 468, the controller/processor 459, the memory 460 and the data source 467 in FIG. 4 of the present application.

In one embodiment, the first transmitter 1302 comprises at least the first four of the antenna 452, the transmitter 454, the multi-antenna transmitting processor 457, the transmitting processor 468, the controller/processor 459, the memory 460 and the data source 467 in FIG. 4 of the present application.

In one embodiment, the first transmitter 1302 comprises at least the first two of the antenna 452, the transmitter 454, the multi-antenna transmitting processor 457, the transmitting processor 468, the controller/processor 459, the memory 460 and the data source 467 in FIG. 4 of the present application.

In one embodiment, the first transmitter 1302 comprises at least the first two of the antenna 452, the transmitter 454, the multi-antenna transmitting processor 457, the transmitting processor 468, the controller/processor 459, the memory 460 and the data source 467 in FIG. 4 of the present application.

In Embodiment 13, the first receiver 1301 receives Q1 bit blocks, Q1 being a positive integer greater than 1; and the first transmitter 1302 transmits a first message and a first bit block; herein, the first message is used for indicating an associated bit block set of each bit in the first bit block, and the associated bit block set of each bit in the first bit block comprises at least one bit block among the Q1 bit blocks, and each bit in the first bit block is used for indicating whether a corresponding associated bit block set is correctly decoded.

In one embodiment, the first bit block consists of Q2 bits, Q2 being a positive integer less than Q1; the associated bit block set of each bit of the Q2 bits consists of one or multiple bit blocks among the Q1 bit blocks; any of the Q1 bit blocks is associated with only one bit of the Q2 bit(s).

In one embodiment, any of the Q2 bit(s) is a HARQ-ACK information bit.

In one embodiment, any of the Q1 bit blocks belongs to only one bit block group of Q3 bit block group(s); any bit in the first bit block belongs to only one bit sub-block of Q3 bit sub-blocks; the Q3 bit sub-blocks respectively indicate whether bit blocks in the Q3 bit block groups are correctly decoded, the Q3 bit sub-blocks respectively corresponding to the Q3 bit block groups; for any of the Q3 bit sub-blocks, the first message is used for indicating an associated bit block set of each bit from a corresponding bit block group; Q3 is a positive integer greater than 1 and less than Q1.

In one embodiment, a second bit block consists of Q4 bits, and each bit block among the Q1 bit blocks corresponds to one bit among the Q4 bits, Q4 being a positive integer greater than 1; the first message is used for indicating an associated bit set of each bit in the first bit block, the associated bit set of each bit in the first bit block comprising at least one bit among the Q4 bits; an associated bit block set of a given bit in the first bit block comprises all bit block(s) among the Q1 bit blocks that corresponds/correspond to any bit in an associated bit set of the given bit in the first bit block.

In one embodiment, any of the Q4 bit(s) is a HARQ-ACK information bit.

In one embodiment, the first receiver 1301 receives a first signaling; herein, the first signaling is used for indicating L1 association methods, and the first message is used for indicating a first association method among the L1 association methods, the first association method being used to determine bit block(s) associated with each bit in the first bit block among the Q1 bit blocks; L1 is a positive integer greater than 1.

In one embodiment, the first message and the first bit block are transmitted on a same physical layer channel.

In one embodiment, the first message and the first bit block are transmitted respectively on two physical layer channels.

### Embodiment 14

Embodiment 14 illustrates a structure block diagram of a processing device in a second node, as shown in FIG. 14. In FIG. 14, a processing device 1400 in a second node comprises a second transmitter 1401 and a second receiver 1402.

In one embodiment, the second node 1400 is a UE.

In one embodiment, the second node 1400 is a base station.

In one embodiment, the second node 1400 is a relay node.

In one embodiment, the second node 1400 is vehicle-mounted communication equipment.

In one embodiment, the second node 1400 is a UE supporting V2X communications.

In one embodiment, the second transmitter 1401 comprises at least one of the antenna 420, the transmitter 418, the multi-antenna transmitting processor 471, the transmitting processor 416, the controller/processor 475 or the memory 476 in FIG. 4 of the present application.

In one embodiment, the second transmitter 1401 comprises at least the first five of the antenna 420, the transmitter 418, the multi-antenna transmitting processor 471, the transmitting processor 416, the controller/processor 475 and the memory 476 in FIG. 4 of the present application.

In one embodiment, the second transmitter 1401 comprises at least the first four of the antenna 420, the transmitter 418, the multi-antenna transmitting processor 471, the transmitting processor 416, the controller/processor 475 and the memory 476 in FIG. 4 of the present application.

In one embodiment, the second transmitter 1401 comprises at least the first three of the antenna 420, the transmitter 418, the multi-antenna transmitting processor 471, the transmitting processor 416, the controller/processor 475 and the memory 476 in FIG. 4 of the present application.

In one embodiment, the second transmitter 1401 comprises at least the first two of the antenna 420, the transmitter 418, the multi-antenna transmitting processor 471, the transmitting processor 416, the controller/processor 475 and the memory 476 in FIG. 4 of the present application.

In one embodiment, the second receiver 1402 comprises at least one of the antenna 420, the receiver 418, the multi-antenna receiving processor 472, the receiving processor 470, the controller/processor 475 or the memory 476 in FIG. 4 of the present application.

In one embodiment, the second receiver 1402 comprises at least the first five of the antenna 420, the receiver 418, the multi-antenna receiving processor 472, the receiving processor 470, the controller/processor 475 and the memory 476 in FIG. 4 of the present application.

In one embodiment, the second receiver 1402 comprises at least the first four of the antenna 420, the receiver 418, the multi-antenna receiving processor 472, the receiving processor 470, the controller/processor 475 and the memory 476 in FIG. 4 of the present application.

In one embodiment, the second receiver 1402 comprises at least the first three of the antenna 420, the receiver 418, the multi-antenna receiving processor 472, the receiving processor 470, the controller/processor 475 and the memory 476 in FIG. 4 of the present application.

In one embodiment, the second receiver 1402 comprises at least the first two of the antenna 420, the receiver 418, the multi-antenna receiving processor 472, the receiving processor 470, the controller/processor 475 and the memory 476 in FIG. 4 of the present application.

In Embodiment 14, the second transmitter 1401 transmits Q1 bit blocks, Q1 being a positive integer greater than 1; the second receiver 1402 receives a first message and a first bit block; herein, the first message is used for indicating an associated bit block set of each bit in the first bit block, and the associated bit block set of each bit in the first bit block comprises at least one bit block among the Q1 bit blocks, and each bit in the first bit block is used for indicating whether a corresponding associated bit block set is correctly decoded.

In one embodiment, the first bit block consists of Q2 bits, Q2 being a positive integer less than Q1; the associated bit block set of each bit of the Q2 bits consists of one or multiple bit blocks among the Q1 bit blocks; any of the Q1 bit blocks is associated with only one bit of the Q2 bit(s).

In one embodiment, any of the Q2 bit(s) is a HARQ-ACK information bit.

In one embodiment, any of the Q1 bit blocks belongs to only one bit block group of Q3 bit block group(s); any bit in the first bit block belongs to only one bit sub-block of Q3 bit sub-blocks; the Q3 bit sub-blocks respectively indicate whether bit blocks in the Q3 bit block groups are correctly decoded, the Q3 bit sub-blocks respectively corresponding to the Q3 bit block groups; for any of the Q3 bit sub-blocks, the first message is used for indicating an associated bit block set of each bit from a corresponding bit block group; Q3 is a positive integer greater than 1 and less than Q1.

In one embodiment, a second bit block consists of Q4 bits, and each bit block among the Q1 bit blocks corresponds to one bit among the Q4 bits, Q4 being a positive integer greater than 1; the first message is used for indicating an associated bit set of each bit in the first bit block, the associated bit set of each bit in the first bit block comprising at least one bit among the Q4 bits; an associated bit block set of a given bit in the first bit block comprises all bit block(s) among the Q1 bit blocks that corresponds/correspond to any bit in an associated bit set of the given bit in the first bit block.

In one embodiment, any of the Q4 bit(s) is a HARQ-ACK information bit.

In one embodiment, the second transmitter 1401 transmits a first signaling; herein, the first signaling is used for indicating L1 association methods, and the first message is used for indicating a first association method among the L1 association methods, the first association method being used to determine bit block(s) associated with each bit in the first bit block among the Q1 bit blocks; L1 is a positive integer greater than 1.

In one embodiment, the first message and the first bit block are transmitted on a same physical layer channel.

In one embodiment, the first message and the first bit block are transmitted respectively on two physical layer channels.

The ordinary skill in the art may understand that all or part of steps in the above method may be implemented by instructing related hardware through a program. The program may be stored in a computer readable storage medium, for example Read-Only-Memory (ROM), hard disk or compact disc, etc. Optionally, all or part of steps in the above embodiments also may be implemented by one or more integrated circuits. Correspondingly, each module unit in the above embodiment may be realized in the form of hardware, or in the form of software function modules. The present application is not limited to any combination of hardware and software in specific forms. The first node in the present application includes but is not limited to mobile phones, tablet computers, notebooks, network cards, low-consumption equipment, enhanced MTC (eMTC) terminals, NB-IOT terminals, vehicle-mounted communication equipment, aircrafts, airplanes, unmanned aerial vehicles, telecontrolled aircrafts, etc. The second node in the present application includes but is not limited to mobile phones, tablet computers, notebooks, network cards, low-consumption equipment, enhanced MTC (eMTC) terminals, NB-IOT terminals, vehicle-mounted communication equipment, aircrafts, airplanes, unmanned aerial vehicles, telecontrolled aircrafts, etc. The UE or terminal in the present application includes but is not limited to mobile phones, tablet computers, notebooks, network cards, low-consumption equipment, enhanced MTC (eMTC) terminals, NB-IOT terminals, vehicle-mounted communication equipment, aircrafts, airplanes, unmanned aerial vehicles, telecontrolled aircrafts, etc. The base station in the present application includes but is not limited to macro-cellular base stations, micro-cellular base stations, home base stations, relay base station, eNB, gNB, Transmitter Receiver Point (TRP), GNSS, relay satellite, satellite base station, airborne base station, test apparatus, test equipment or test instrument, and other radio communication equipment.

It will be appreciated by those skilled in the art that this disclosure can be implemented in other designated forms without departing from the core features or fundamental characters thereof. The currently disclosed embodiments, in any case, are therefore to be regarded only in an illustrative, rather than a restrictive sense. The scope of invention shall be determined by the claims attached, rather than according to previous descriptions, and all changes made with equivalent meaning are intended to be included therein.

What is claimed is:

1. A first node for wireless communications, characterized in comprising:
a first receiver, receiving Q1 bit blocks, Q1 being a positive integer greater than 1; and
a first transmitter, transmitting a first message and a first bit block;
wherein the first message is used for indicating an associated bit block set of each bit in the first bit block, and the associated bit block set of each bit in the first bit block comprises at least one bit block among the Q1 bit blocks, and each bit in the first bit block is used for indicating whether a corresponding associated bit block set is correctly decoded.

2. The first node according to claim 1, characterized in that the first bit block consists of Q2 bit(s), Q2 being a positive integer less than Q1; the associated bit block set of each bit of the Q2 bit(s) consists of one or multiple bit blocks among the Q1 bit blocks; any of the Q1 bit blocks is associated with only one bit of the Q2 bit(s).

3. The first node according to claim 1, characterized in that any of the Q1 bit blocks belongs to only one bit block group of Q3 bit block groups; any bit in the first bit block belongs to only one bit sub-block of Q3 bit sub-blocks; the Q3 bit sub-blocks respectively indicate whether bit blocks in the Q3 bit block groups are correctly decoded, the Q3 bit sub-blocks respectively corresponding to the Q3 bit block groups; for any of the Q3 bit sub-blocks, the first message is used for indicating an associated bit block set of each bit from a corresponding bit block group; Q3 is a positive integer greater than 1 and less than Q1.

4. The first node according to claim 1, characterized in that a second bit block consists of Q4 bits, and each bit block among the Q1 bit blocks corresponds to one bit among the Q4 bits, Q4 being a positive integer greater than 1; the first message is used for indicating an associated bit set of each bit in the first bit block, the associated bit set of each bit in the first bit block comprising at least one bit among the Q4 bits; an associated bit block set of a given bit in the first bit block comprises all bit block(s) among the Q1 bit blocks that corresponds/correspond to any bit in an associated bit set of the given bit in the first bit block.

5. The first node according to claim 1, characterized in comprising:
the first receiver, receiving a first signaling;
wherein the first signaling is used for indicating L1 association methods, and the first message is used for indicating a first association method among the L1 association methods, the first association method being used to determine bit block(s) associated with each bit in the first bit block among the Q1 bit blocks; L 1 is a positive integer greater than 1.

6. The first node according to claim 1, characterized in that the first message and the first bit block are transmitted on a same physical layer channel.

7. The first node according to claim 1, characterized in that the first message and the first bit block are transmitted respectively on two physical layer channels.

8. A second node for wireless communications, characterized in comprising:
a second transmitter, transmitting Q1 bit blocks, Q1 being a positive integer greater than 1; and
a second receiver, receiving a first message and a first bit block;
wherein the first message is used for indicating an associated bit block set of each bit in the first bit block, and the associated bit block set of each bit in the first bit block comprises at least one bit block among the Q1 bit blocks, and each bit in the first bit block is used for indicating whether a corresponding associated bit block set is correctly decoded.

9. The second node according to claim 8, characterized in that the first bit block consists of Q2 bit(s), Q2 being a positive integer less than Q1; the associated bit block set of each bit of the Q2 bit(s) consists of one or multiple bit blocks among the Q1 bit blocks; any of the Q1 bit blocks is associated with only one bit of the Q2 bit(s).

10. The second node according to claim 8, characterized in that any of the Q1 bit blocks belongs to only one bit block group of Q3 bit block groups; any bit in the first bit block belongs to only one bit sub-block of Q3 bit sub-blocks; the Q3 bit sub-blocks respectively indicate whether bit blocks in the Q3 bit block groups are correctly decoded, the Q3 bit sub-blocks respectively corresponding to the Q3 bit block groups; for any of the Q3 bit sub-blocks, the first message is used for indicating an associated bit block set of each bit from a corresponding bit block group; Q3 is a positive integer greater than 1 and less than Q1.

11. The second node according to claim 8, characterized in that a second bit block consists of Q4 bits, and each bit block among the Q1 bit blocks corresponds to one bit among the Q4 bits, Q4 being a positive integer greater than 1; the first message is used for indicating an associated bit set of each bit in the first bit block, the associated bit set of each bit in the first bit block comprising at least one bit among the Q4 bits; an associated bit block set of a given bit in the first bit block comprises all bit block(s) among the Q1 bit blocks that corresponds/correspond to any bit in an associated bit set of the given bit in the first bit block.

12. The second node according to claim 8, characterized in comprising:
the second transmitter, transmitting a first signaling;
wherein the first signaling is used for indicating L1 association methods, and the first message is used for indicating a first association method among the L1 association methods, the first association method being used to determine bit block(s) associated with each bit in the first bit block among the Q1 bit blocks; L 1 is a positive integer greater than 1.

13. The second node according to claim 8, characterized in that the first message and the first bit block are transmitted on a same physical layer channel.

14. A method in a first node for wireless communications, characterized in comprising:
receiving Q1 bit blocks, Q1 being a positive integer greater than 1; and
transmitting a first message and a first bit block;
wherein the first message is used for indicating an associated bit block set of each bit in the first bit block, and the associated bit block set of each bit in the first bit block comprises at least one bit block among the Q1 bit blocks, and each bit in the first bit block is used for indicating whether a corresponding associated bit block set is correctly decoded.

15. The method in the first node according to claim 14, characterized in that the first bit block consists of Q2 bit(s), Q2 being a positive integer less than Q1; the associated bit block set of each bit of the Q2 bit(s) consists of one or multiple bit blocks among the Q1 bit blocks; any of the Q1 bit blocks is associated with only one bit of the Q2 bit(s).

16. The method in the first node according to claim 14, characterized in that any of the Q1 bit blocks belongs to only one bit block group of Q3 bit block groups; any bit in the first bit block belongs to only one bit sub-block of Q3 bit sub-blocks; the Q3 bit sub-blocks respectively indicate whether bit blocks in the Q3 bit block groups are correctly decoded, the Q3 bit sub-blocks respectively corresponding to the Q3 bit block groups; for any of the Q3 bit sub-blocks, the first message is used for indicating an associated bit block set of each bit from a corresponding bit block group; Q3 is a positive integer greater than 1 and less than Q1.

17. The method in the first node according to claim 14, characterized in that a second bit block consists of Q4 bits, and each bit block among the Q1 bit blocks corresponds to one bit among the Q4 bits, Q4 being a positive integer greater than 1; the first message is used for indicating an associated bit set of each bit in the first bit block, the associated bit set of each bit in the first bit block comprising at least one bit among the Q4 bits; an associated bit block set of a given bit in the first bit block comprises all bit block(s) among the Q1 bit blocks that corresponds/correspond to any bit in an associated bit set of the given bit in the first bit block.

18. The method in the first node according to claim 14, characterized in comprising:
receiving a first signaling;
wherein the first signaling is used for indicating L1 association methods, and the first message is used for indicating a first association method among the L1 association methods, the first association method being used to determine bit block(s) associated with each bit in the first bit block among the Q1 bit blocks; L1 is a positive integer greater than 1.

19. The method in the first node according to claim 14, characterized in that the first message and the first bit block are transmitted on a same physical layer channel.

20. The method in the first node according to claim 14, characterized in that the first message and the first bit block are transmitted respectively on two physical layer channels.
